(19) United States
(12) Patent Application Publication
(10) Pub. No.: US 2017/0131857 A1
(43) Pub. Date: May 11, 2017

(54) WALLPAPER PROCESSING METHOD AND ELECTRONIC DEVICE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Hongtao ZHAO, Beijing (CN)

(21) Appl. No.: 15/245,015

(22) Filed: Aug. 23, 2016

Related U.S. Application Data
(63) Continuation of application No. PCT/CN2016/088400, filed on Jul. 4, 2016.

(30) Foreign Application Priority Data
Nov. 6, 2015 (CN) 201510756453.1

(51) Int. Cl. G06F 3/0482; G06F 3/0481

(52) U.S. Cl. CPC G06F 3/0482; G06F 3/04817

(57) ABSTRACT

The embodiment of the present disclosure discloses a wallpaper processing method and electronic device. The method specifically comprises the steps of monitoring the state of wallpaper and, when the wallpaper is monitored to change, obtaining the changed wallpaper, and storing the changed wallpaper into a wallpaper record. Through the adoption of the embodiment of the present disclosure, the efficiency of obtaining the used wallpaper can be improved.

### CROSS-REFERENCE TO RELATED APPLICATIONS

This application is a continuation of International Application No. PCT/CN2016/088400, filed on Jul. 4, 2016, which claims priority of Chinese patent application No. 201510756453.1, filed on Nov. 6, 2015 and is incorporated herein by reference in its entirety.

### FIELD OF TECHNOLOGY

The present disclosure relates to the field of information technology, in particular to a wallpaper processing method and electronic device.

### BACKGROUND

With the rapid development of the information technology, cell phones have been popularized in the lives of people, and most cell phones have a function for switching wallpaper.

A user can switch the wallpaper according to personal preference, for example, the user can switch the current wallpaper from wallpaper 1 to wallpaper 2.

However, after a plurality of time intervals, if the user wants to switch the wallpaper back to the wallpaper 1, the user needs to perform a search operation to search for wallpaper 1 in local folders. Additionally, when wallpaper 1 cannot be searched in the local folders because wallpaper 1 is lost or deleted, the user needs to perform the operations of re-searching and downloading wallpaper 1 from the Internet to obtain wallpaper 1, and the conventional scheme requires complicated processes; therefore, the efficiency of obtaining the used wallpaper is reduced.

### SUMMARY

The embodiment of the present disclosure discloses a wallpaper processing method and electronic device for solving the problem that the efficiency of obtaining the used wallpaper is reduced because of complicated processes of obtaining the used wallpaper in the prior art, and improving the efficiency of obtaining the used wallpaper.

According to one aspect of the present disclosure, the embodiment of the present disclosure provides a wallpaper processing method, including:

monitoring the state of wallpaper;

obtaining the changed wallpaper when the wallpaper is monitored to change; and

storing the changed wallpaper into a wallpaper record.

According to another aspect of the present disclosure, the embodiment of the present disclosure provides an electronic device for wallpaper processing, including at least one processor; and a memory communicably connected with the at least one processor for storing instructions executable by the at least one processor, wherein execution of the instructions by the at least one processor causes the at least one processor to:

monitor the state of the wallpaper;

obtain the changed wallpaper when the wallpaper is monitored to change; and

store the changed wallpaper into the wallpaper record.

According to another aspect of the present disclosure, a computer procedure is provided, including a computer readable code, wherein when the computer readable code runs on an electronic device, the electronic device executes the wallpaper processing method.

According to another aspect of the present disclosure, a computer readable medium is provided, wherein the computer procedure is stored in the computer readable medium.

According to the wallpaper processing method and device provided by the embodiment of the present disclosure, when the wallpaper is monitored to change, the changed wallpaper can be obtained and can be stored into the wallpaper record; compared with the conventional scheme of searching the used wallpaper through the local folders or the network, the embodiment of the present disclosure can enable the user to obtain the used wallpaper through the wallpaper record, because the quantity of the wallpaper stored in the wallpaper record is far smaller than the quantity of pictures in the local folders or the network, the embodiment of the present disclosure can enable the user to shorten the time of searching the used wallpaper, so that the efficiency of obtaining the used wallpaper can be improved.

The description above is only the summary of the technical scheme of the present disclosure, in order to enable people to clearly understand the technical means of the present disclosure and implement the technical means in accordance with the contents of the specifications, and in order to enable the above and other aims, the characteristics and the advantages of the present disclosure to be more obvious and understandable, the specific embodiments of the present disclosure are particularly listed in the followings.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is the flow chart of steps of the wallpaper processing method disclosed by the embodiment 1 of the present disclosure.

FIG. 2 is the flow chart of steps of the wallpaper processing method disclosed by the embodiment 2 of the present disclosure.

FIG. 3 is the flow chart of steps of the wallpaper processing method disclosed by the embodiment 3 of the present disclosure.

FIG. 4 is the flow chart of steps of the wallpaper processing method disclosed by the embodiment 4 of the present disclosure.

FIG. 5 is the flow chart of steps of the wallpaper processing method disclosed by the embodiment 5 of the present disclosure.

FIG. 6 is the flow chart of steps of the wallpaper processing method disclosed by the embodiment 6 of the present disclosure.

FIG. 7 is the flow chart of steps of the wallpaper processing method disclosed by the embodiment 7 of the present disclosure.

FIG. 8 is the schematic structural view of the wallpaper processing device disclosed by the embodiment 1 of the present disclosure.

FIG. 9 is the schematic structural view of the wallpaper processing device disclosed by the embodiment 2 of the present disclosure.

FIG. 10 is the schematic structural view of the wallpaper processing device disclosed by the embodiment 3 of the present disclosure.

FIG. 11 is the schematic structural view of the wallpaper processing device disclosed by the embodiment 4 of the present disclosure.

FIG. 12 is the schematic structural view of the wallpaper processing device disclosed by the embodiment 5 of the present disclosure.

FIG. 13 is the schematic structural view of the wallpaper processing device disclosed by the embodiment 6 of the present disclosure.

FIG. 14 is the schematic structural view of the wallpaper processing device disclosed by the embodiment 7 of the present disclosure.

FIG. 15 is the schematic structural view of the wallpaper processing device disclosed by the embodiment 8 of the present disclosure.

FIG. 16 schematically illustrates the block diagram of an electronic device for executing the method according to the present disclosure.

FIG. 17 schematically illustrates a storage unit for keeping or carrying procedure codes for realizing the method according to the present disclosure.

### DESCRIPTION OF THE EMBODIMENTS

In order to enable the aims, the technical schemes and the advantages of the embodiments of the present disclosure to be clear, the technical schemes of the embodiments of the present disclosure are clearly and completely described by combining the following figures in the embodiments of the present disclosure; obviously, the described embodiments are not total embodiments, but one part of the embodiments of the present disclosure. Based on the embodiments of the present disclosure, all other embodiments obtained by those skilled in the prior art under the premise that creative work is not made all belong to the protection scope of the present disclosure.

### Embodiment 1 of the Method

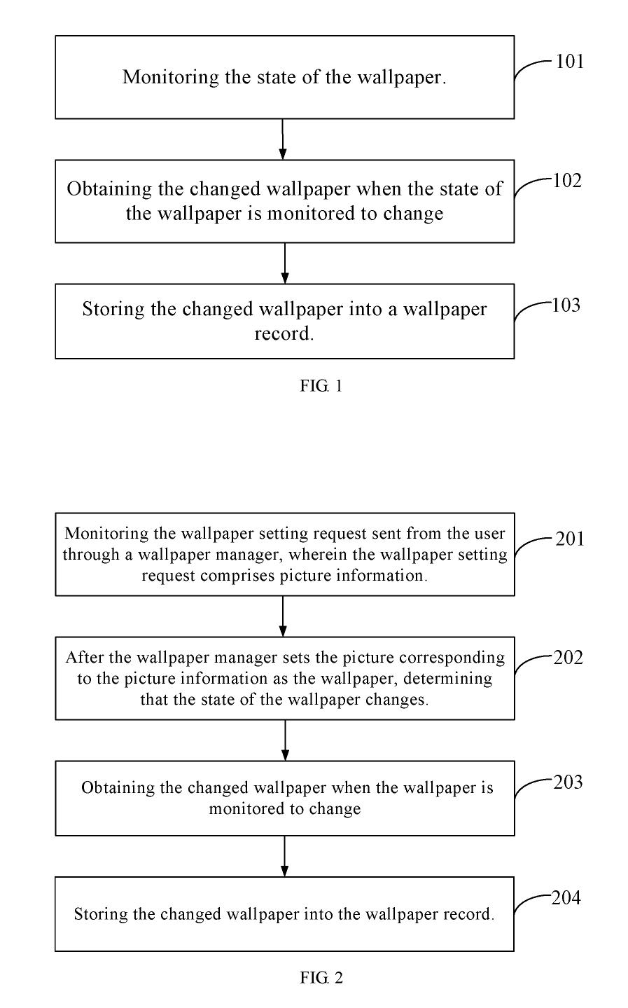

As shown in FIG. 1, the flow chart of steps of the wallpaper processing method disclosed by the embodiment 1 of the present disclosure is illustrated, specifically includes steps as follows.

Step 101, monitoring the state of the wallpaper.

The embodiment of the present disclosure can be applied to mobile terminals of cell phones, tablet computers and the like, for storing the used wallpaper (hereinafter referred to as historical wallpaper) by the user in the mobile terminals to provide the way of obtaining the historical wallpaper for the user according to the stored historical wallpaper, so that the efficiency of obtaining the historical wallpaper is improved.

In the embodiment of the present disclosure, the state of the wallpaper can be the state whether the wallpaper changes, namely whether the wallpaper is switched.

In the embodiment of the present disclosure, the state of the wallpaper can be the state of the wallpaper, capable of displaying the applications of the wallpaper, wherein the displayed applications of the wallpaper can specifically include a screen lock application, a desktop application and the like.

As will be appreciated that the screen lock application and the desktop application are only used as an example of the application suitable for the state of the wallpaper in the embodiment of the present disclosure, rather than the limit to the application suitable for the state of the wallpaper, in fact, all the applications capable of displaying the wallpaper can be used as the applications suitable for the state of the wallpaper in the embodiment of the present disclosure, and the embodiment of the present disclosure does not limit the applications suitable for the state of the wallpaper.

Step 102, obtaining the changed wallpaper when the state of the wallpaper is monitored to change.

In the embodiment of the present disclosure, when the wallpaper is monitored to change, the changed wallpaper can be obtained, for example, when the wallpaper is switched, the state of the wallpaper is changed, and when the wallpaper is switched from the wallpaper 1 to the wallpaper 2, the wallpaper 2 is the changed wallpaper.

Step 103, storing the changed wallpaper into the wallpaper record.

In the embodiment of the present disclosure, the wallpaper record can be used for storing the historical wallpaper. In the specific realization process, after the changed wallpaper is obtained, the wallpaper can be backed up, and the backed-up wallpaper is stored into the wallpaper record.

In conclusion, according to the embodiment of the present disclosure, when the wallpaper is monitored to change, the changed wallpaper can be obtained and can be stored in the wallpaper record; compared with the conventional scheme of searching the used wallpaper through the local folders or the network, the embodiment of the present disclosure can enable the user to obtain the used wallpaper through the wallpaper record, because the quantity of the wallpaper stored in the wallpaper record is far smaller than the quantity of pictures in the local folders or the network, the embodiment of the present disclosure can enable the user to shorten the time of searching the used wallpaper, so that the efficiency of obtaining the used wallpaper can be improved.

### Embodiment 2 of the Method

As shown in FIG. 2, the flow chart of steps of the wallpaper processing method disclosed by the embodiment 2 of the present disclosure is illustrated, specifically includes steps as follows.

Step 201, monitoring the wallpaper setting request sent from the user through a wallpaper manager, wherein the wallpaper setting request includes picture information.

Step 202, determining that the state of the wallpaper changes after the wallpaper manager sets the picture corresponding to the picture information as the wallpaper.

Step 203, obtaining the changed wallpaper when the wallpaper is monitored to change.

In one embodiment of the present disclosure, obtaining the changed wallpaper according to the picture path or the picture address information in the picture information.

In the embodiment of the present disclosure, reading the picture corresponding to the picture information by opening a byte stream InputStream, specifically positioning the position of the picture through the picture path or the picture address information by InputStream to read the picture.

Step 204, storing the changed wallpaper into the wallpaper record.

Compared with the embodiment 1 of the method, the embodiment describes the specific course of monitoring the state of the wallpaper through the step 201 and the step 202, in the course, the wallpaper setting request sent from the user can be monitored through the wallpaper manager, and because the wallpaper manager can be used for being responsible for the wallpaper management function of an operating system and processing the wallpaper setting request, in the course, the changes of the state of the wallpaper can be timely and accurately obtained.

In the embodiment of the present disclosure, after selecting the picture as the wallpaper, the user can send out the wallpaper setting request to the wallpaper manager through a wallpaper setting control element on an interface, the wallpaper setting request can include the picture information of the selected picture so as to enable the wallpaper manager to obtain the corresponding picture according to the picture information and set the obtained picture as the wallpaper, wherein the picture information can specifically include a picture path, or picture address information and the like, and the embodiment of the present disclosure does not limit the specific picture information.

In the embodiment of the present disclosure, after receiving the wallpaper setting request sent from the user, the wallpaper manager can process the wallpaper setting request, when the processing of the wallpaper setting request is completed, namely after the picture corresponding to the picture information in the wallpaper setting request is set as the wallpaper, the situation that the state of the wallpaper is changed is determined.

### Embodiment 3 of the Method

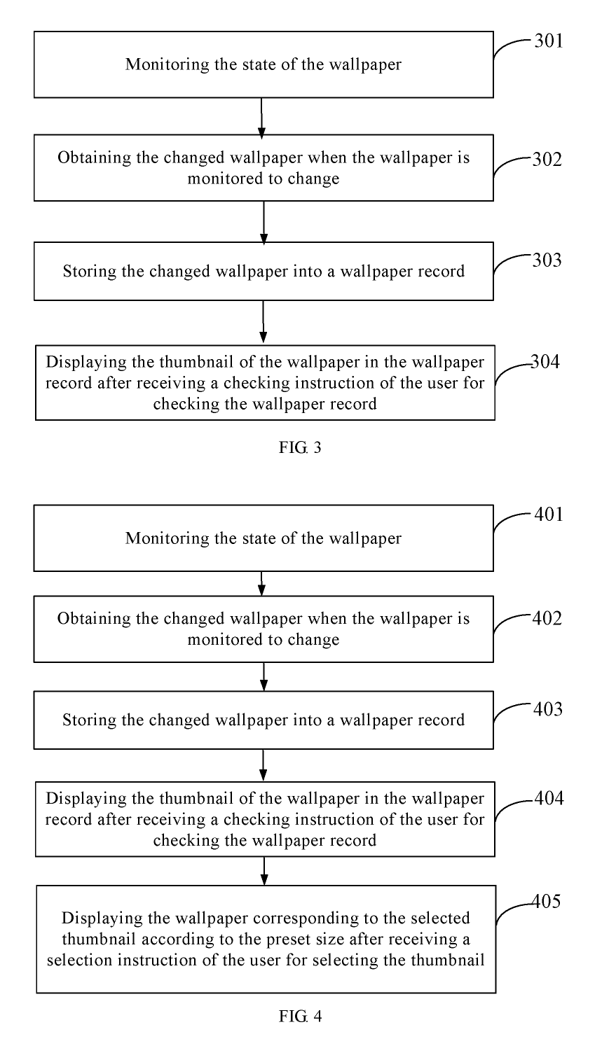

As shown in FIG. 3, the flow chart of steps of the wallpaper processing method disclosed by the embodiment 3 of the present disclosure is illustrated, specifically including:

step 301, monitoring the state of the wallpaper;

step 302, obtaining the changed wallpaper when the wallpaper is monitored to change;

step 303, storing the changed wallpaper into the wallpaper record;

step 304, displaying the thumbnail of the wallpaper in the wallpaper record after receiving a checking instruction of the user for checking the wallpaper record.

Compared with the embodiment 1 of the method, the embodiment increases the step 304, in the step 304, after the checking instruction of the user for checking the wallpaper record are received, the thumbnail of the wallpaper in the wallpaper record can be displayed; because the size of the thumbnail is smaller, the thumbnails of multiple pieces of wallpaper can be displayed in the interface, so that the user can browse multiple pieces of wallpaper on one page; compared with the condition that one piece of the wallpaper is displayed on one interface, the time of browsing the wallpaper is saved, so that the efficiency of obtaining the used wallpaper can be improved.

In the embodiment of the present disclosure, one thumbnail is the abbreviate display of one piece of the wallpaper, after the checking instruction of the user for checking the wallpaper record are received, the first wallpaper can be extracted from the wallpaper record according to the marshalling sequence of the wallpaper in the wallpaper record, the display size of the thumbnail of the first wallpaper is determined, the thumbnails of the other wallpaper are displayed on the interface according to the display size of the thumbnail of the first wallpaper, wherein the marshalling sequence of the wallpaper in the wallpaper record can be the back-to-front time sequence or the front-to-back time sequence and the like, and the embodiment of the present disclosure does not limit the specific marshalling sequence.

As will be appreciated that displaying the thumbnail of the wallpaper in the wallpaper record is only used as an example of the present disclosure, the embodiment of the present disclosure does not limit the specific method for displaying the thumbnail of the wallpaper in the wallpaper record.

### Embodiment 4 of the Method

As shown in FIG. 4, the flow chart of steps of the wallpaper processing method disclosed by the embodiment 4 of the present disclosure is illustrated, specifically including:

step 401, monitoring the state of the wallpaper;

step 402, obtaining the changed wallpaper when the wallpaper is monitored to change;

step 403, storing the changed wallpaper into the wallpaper record;

step 404, displaying the thumbnail of the wallpaper in the wallpaper record after receiving a checking instruction of the user for checking the wallpaper record;

step 405, displaying the wallpaper corresponding to the selected thumbnail according to the preset size after receiving a selection instruction of the user for selecting the thumbnail.

Compared with the embodiment 3 of the method, the embodiment increases the step 405, in the step 405, after the selection instruction of the user for selecting the thumbnail are received, the wallpaper corresponding to the selected thumbnail can be displayed according to the preset size, so that the user can perform amplified checking (such as full-screen checking) on the wallpaper that the user is interested.

In the embodiment of the present disclosure, the preset size can be any size adapted to be displayed by the screen of the mobile terminal, for example, the preset size can be ¾ of the full-screen size, which is voluntarily determined by those skilled in the prior art, and the embodiment of the present disclosure does not specifically limit the specific preset size.

In the embodiment of the present disclosure, after the selection instruction of the user for selecting the thumbnail are received, the wallpaper is searched and obtained according to the picture path or the picture address information of the wallpaper corresponding to the thumbnail, so that the wallpaper corresponding to the selected thumbnail is displayed on the interface according to the preset size.

### Embodiment 5 of the Method

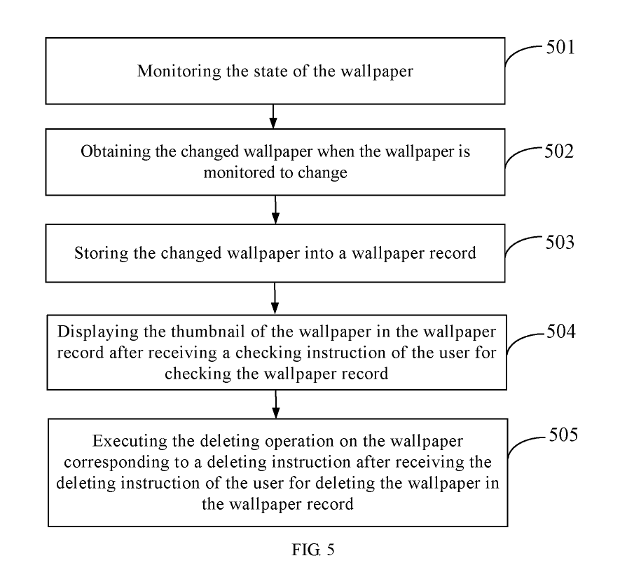

As shown in FIG. 5, the flow chart of steps of the wallpaper processing method disclosed by the embodiment 5 of the present disclosure is illustrated, specifically including:

step 501, monitoring the state of the wallpaper;

step 502, obtaining the changed wallpaper when the wallpaper is monitored to change;

step 503, storing the changed wallpaper into the wallpaper record;

step 504, displaying the thumbnail of the wallpaper in the wallpaper record after receiving a checking instruction of the user for checking the wallpaper record;

step 505, executing the deleting operation on the wallpaper corresponding to a deleting instruction after receiving the deleting instruction of the user for deleting the wallpaper in the wallpaper record.

Compared with the embodiment 3 of the method, the embodiment increases the step 505, in the step 505, after the deleting instruction of the user for deleting the wallpaper in the wallpaper record are received, the deleting operation can be executed on the wallpaper corresponding to the deleting instruction, so that the user can manage the wallpaper in the wallpaper record and delete the wallpaper which is not needed so as to save the storage space.

In the another embodiment of the present disclosure, after the selection instruction of the user for selecting the thumbnail are received, the wallpaper corresponding to the selected thumbnail can be displayed according to the preset size, and then the step 505 can be executed, namely the embodiment of the present disclosure not only can support the function of deleting the wallpaper in the form of thumbnails but also can support the function of deleting the wallpaper in the form of amplified checking.

### Embodiment 6 of the Method

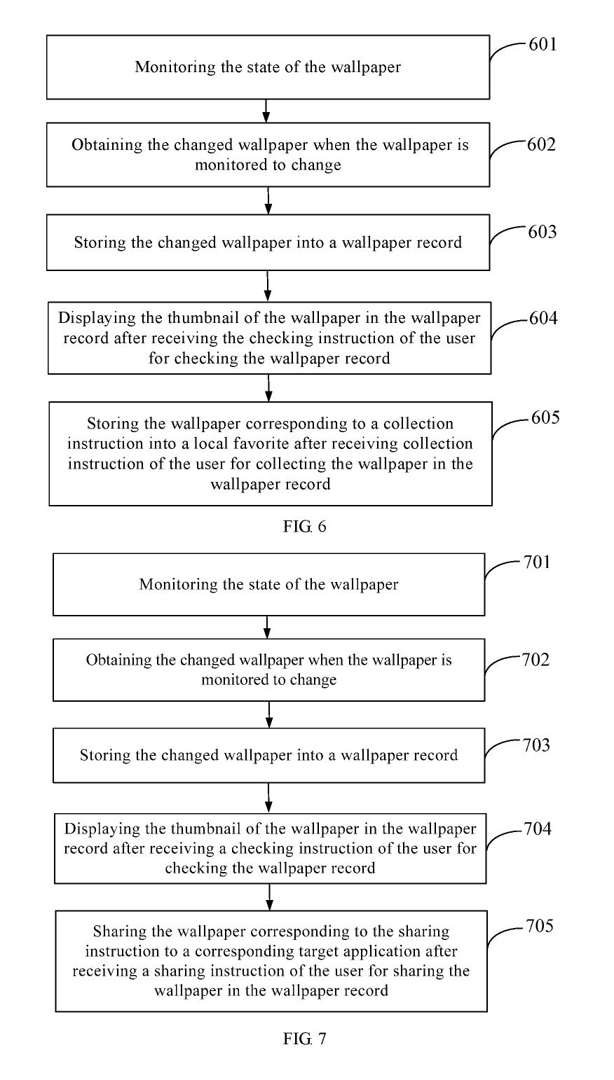

As shown in FIG. 6, the flow chart of steps of the wallpaper processing method disclosed by the embodiment 6 of the present disclosure is illustrated, specifically including:

step 601, monitoring the state of the wallpaper;

step 602, obtaining the changed wallpaper when the wallpaper is monitored to change;

step 603, storing the changed wallpaper into the wallpaper record;

step 604, displaying the thumbnail of the wallpaper in the wallpaper record after receiving the checking instruction of the user for checking the wallpaper record;

step 605, storing the wallpaper corresponding to a collection instruction into a local favorite after receiving collection instruction of the user for collecting the wallpaper in the wallpaper record.

Compared with the embodiment 3 of the method, the embodiment increases the step 605, in the step 605, after the collection instruction of the user for collecting the wallpaper in the wallpaper record are received, the wallpaper corresponding to the collection instruction is backed up and stored into the local favorite according to the collection instruction, and when the wallpaper in the wallpaper record is lost due to losing or mistaken deleting and the like, the corresponding wallpaper can be obtained from the local favorite.

In the embodiment of the present disclosure, after the collection instruction of the user for collecting the wallpaper in the wallpaper record are received, the wallpaper corresponding to the collection instruction can be backed up, the backed-up wallpaper is stored into a collection route designated in the collection instruction, and the embodiment of the present disclosure does not limit the specific collection route.

In the another embodiment of the present disclosure, after the selection instruction of the user for selecting the thumbnail are received, the wallpaper corresponding to the selected thumbnail can be displayed according to the preset size, and then the step 605 can be executed, namely the embodiment of the present disclosure not only can support the function of collecting the wallpaper in the form of the thumbnails but also can support the function of collecting the wallpaper in the form of amplified checking.

### Embodiment 7 of the Method

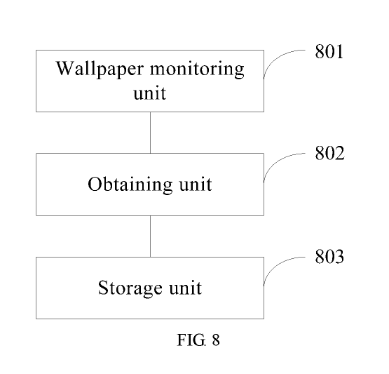

As shown in FIG. 7, the flow chart of steps of the wallpaper processing method disclosed by the embodiment 7 of the present disclosure is illustrated, specifically including:

step 701, monitoring the state of the wallpaper;

step 702, obtaining the changed wallpaper when the wallpaper is monitored to change;

step 703, storing the changed wallpaper into the wallpaper record;

step 704, displaying the thumbnail of the wallpaper in the wallpaper record after receiving a checking instruction of the user for checking the wallpaper record;

step 705, sharing the wallpaper corresponding to the sharing instruction to a corresponding target application after receiving a sharing instruction of the user for sharing the wallpaper in the wallpaper record.

Compared with the embodiment 3 of the method, the embodiment increases the step 705, in the step 705, after the sharing instruction of the user for sharing the wallpaper in the wallpaper record are received, the wallpaper corresponding to the sharing instruction is shared to the corresponding target application to be appreciated by other people.

In the embodiment of the present disclosure, the target application can be a software application of WeChat, micro blog, Tencent QQ and the like, wherein after the sharing instruction of the user for sharing the wallpaper in the wallpaper record are received, the interface corresponding to the target application can be invoked for sharing the wallpaper corresponding to the sharing instruction to the target application to be appreciated by good friends.

In the another embodiment of the present disclosure, after a selection instruction of the user for selecting the thumbnail are received, the wallpaper corresponding to the selected thumbnail can be displayed according to the preset size, and then the step 705 can be executed, namely the embodiment of the present disclosure not only can support the function of sharing the wallpaper in the form of the thumbnails but also can support the function of sharing the wallpaper in the form of the amplified checking.

### Embodiment 1 of the Device

As shown in FIG. 8, the schematic structural view of the wallpaper processing device disclosed by the embodiment 1 of the present disclosure is illustrated, specifically including a wallpaper monitoring unit 801, an obtaining unit 802 and a storage unit 803;

wherein the wallpaper monitoring unit 801 can be used for monitoring the state of the wallpaper;

the obtaining unit 802 can be used for obtaining the changed wallpaper when the wallpaper is monitored to change; and

the storage unit 803 can be used for storing the changed wallpaper into the wallpaper record.

The embodiment of the present disclosure can enable the user to obtain the used wallpaper through the wallpaper record, and the quantity of the wallpaper stored in the wallpaper record is far smaller than the quantity of pictures in the local folders or the network, so that the embodiment of the present disclosure can enable the user to shorten the time of searching the used wallpaper, and the efficiency of obtaining the used wallpaper can be improved.

### Embodiment 2 of the Device

As shown in FIG. 9, the schematic structural view of the wallpaper processing device disclosed by the embodiment 2 of the present disclosure is illustrated, specifically including a wallpaper monitoring unit 901, an obtaining unit 902 and a storage unit 903;

wherein the wallpaper monitoring unit 901 can be used for monitoring the state of the wallpaper;

the obtaining unit 902 can be used for obtaining the changed wallpaper when the wallpaper is monitored to change; and

the storage unit 903 can be used for storing the changed wallpaper into the wallpaper record;

wherein the wallpaper monitoring unit 901 can specifically include:

a monitoring request nodule 9011, wherein the monitoring request module 9011 can be used for monitoring the wallpaper setting request sent from the user through the wallpaper manager, and the wallpaper setting request includes picture information;

a determining module 9012 can be used for determining that the state of the wallpaper changes after the picture corresponding to the picture information is set as the wallpaper through the wallpaper manager.

### Embodiment 3 of the Device

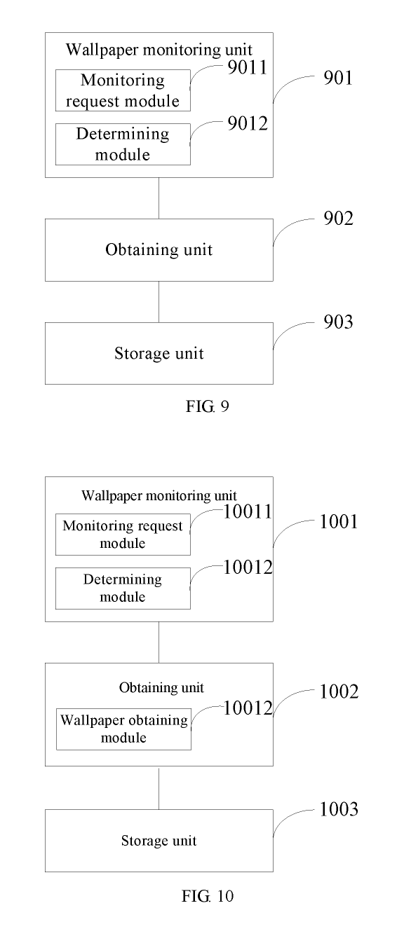

As shown in FIG. 10, the schematic structural view of the wallpaper processing device disclosed by the embodiment 3 of the present disclosure is illustrated, specifically including a wallpaper monitoring unit 1001, an obtaining unit 1002 and a storage unit 1003;

wherein the wallpaper monitoring unit 1001 can be used for monitoring the state of the wallpaper;

the obtaining unit 1002 can be used for obtaining the changed wallpaper when the wallpaper is monitored to change; and

the storage unit 1003 can be used for storing the changed wallpaper into the wallpaper record.

Wherein the wallpaper monitoring unit 1001 can specifically include:

a monitoring request module 10011, wherein the monitoring request module 10011 can be used for monitoring the wallpaper setting request sent from the user through the wallpaper manager, and the wallpaper setting request includes picture information;

a determining module 10012 can be used for determining that the state of the wallpaper changes after the picture corresponding to the picture information is set as the wallpaper through the wallpaper manager.

Wherein the obtaining unit 1002 can specifically include:

a wallpaper obtaining module 10021 that can be used for obtaining the changed wallpaper according to the picture path or the picture address information in the picture information.

### Embodiment 4 of the Device

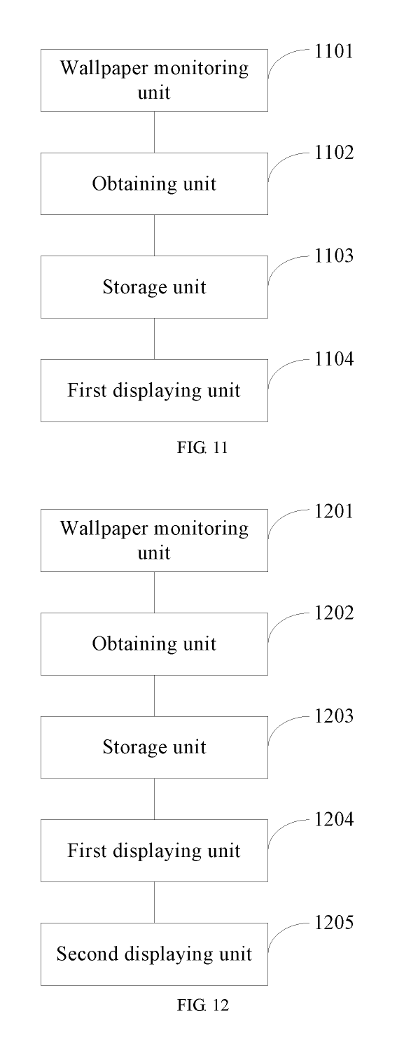

As shown in FIG. 11, the schematic structural view of the wallpaper processing device disclosed by the embodiment 4 of the present disclosure is illustrated, specifically including a wallpaper monitoring unit 1101, an obtaining unit 1102, a storage unit 1103 and a first displaying unit 1104;

wherein the wallpaper monitoring unit 1101 can be used for monitoring the state of the wallpaper;

the obtaining unit 1102 can be used for obtaining the changed wallpaper when the wallpaper is monitored to change;

the storage unit 1103 can be used for storing the changed wallpaper into the wallpaper record;

the first displaying unit 1104 can be used for receiving a checking instruction of the user for checking the wallpaper record and displaying the thumbnail of the wallpaper in the wallpaper record.

### Embodiment 5 of the Device

As shown in FIG. 12, the schematic structural view of the wallpaper processing device disclosed by the embodiment 5 of the present disclosure is illustrated, specifically including a wallpaper monitoring unit 1201, an obtaining unit 1202, a storage unit 1203, a first displaying unit 1204 and a second displaying unit 1205;

wherein the wallpaper monitoring unit 1201 can be used for monitoring the state of the wallpaper;

the obtaining unit 1202 can be used for obtaining the changed wallpaper when the wallpaper is monitored to change;

the storage unit 1203 can be used for storing the changed wallpaper into the wallpaper record;

the first displaying unit 1204 can be used for receiving a checking instruction of the user for checking the wallpaper record and displaying the thumbnail of the wallpaper in the wallpaper record;

the second displaying unit 1205 can be used for receiving the selection instruction of the user for selecting the thumbnail and displaying the wallpaper corresponding to the selected thumbnail according to the preset size.

### Embodiment 6 of the Device

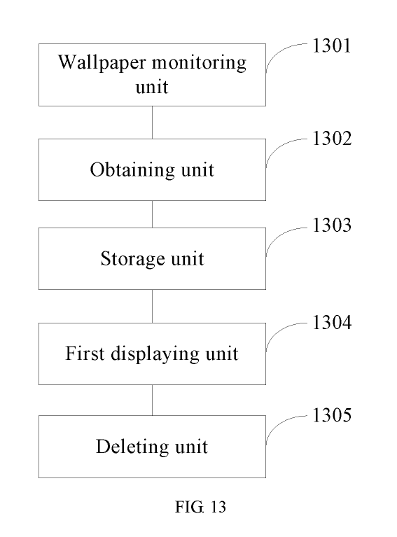

As shown in FIG. 13, the schematic structural view of the wallpaper processing device disclosed by the embodiment 6 of the present disclosure is illustrated, specifically including a wallpaper monitoring unit 1301, an obtaining unit 1302, a storage unit 1303, a first displaying unit 1304 and a deleting unit 1305:

wherein the wallpaper monitoring unit 1301 can be used for monitoring the state of the wallpaper;

the obtaining unit 1302 can be used for obtaining the changed wallpaper when the wallpaper is monitored to change;

the storage unit 1303 can be used for storing the changed wallpaper into the wallpaper record;

the first displaying unit 1304 can be used for receiving a checking instruction of the user for checking the wallpaper record and displaying the thumbnail of the wallpaper in the wallpaper record; and the deleting unit 1305 can be used for receiving a deleting instruction of the user for deleting the wallpaper in the wallpaper record and executing the deleting operation on the wallpaper corresponding to the deleting instruction.

### Embodiment 7 of the Device

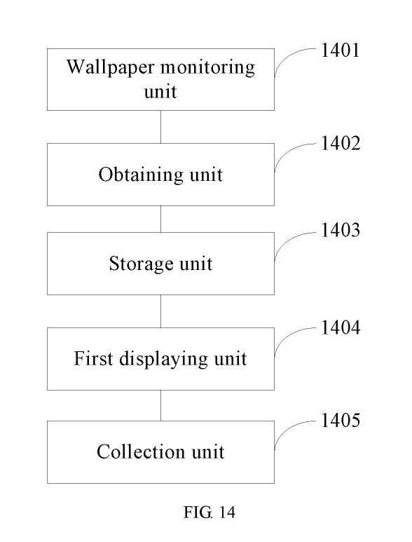

As shown in FIG. 14, the schematic structural view of the wallpaper processing device disclosed by the embodiment 7 of the present disclosure is illustrated, specifically including a wallpaper monitoring unit 1401, an obtaining unit 1402, a storage unit 1403, a first displaying unit 1404 and a collection unit 1405;

wherein the wallpaper monitoring unit 1401 can be used for monitoring the state of the wallpaper;

the obtaining unit 1402 can be used for obtaining the changed wallpaper when the wallpaper is monitored to change;

the storage unit 1403 can be used for storing the changed wallpaper into the wallpaper record;

the first displaying unit 1404 can be used for receiving a checking instruction of the user for checking the wallpaper record and displaying the thumbnail of the wallpaper in the wallpaper record; and the collection unit 1405 can be used for receiving a collection instruction of the user for collecting the wallpaper in the wallpaper record and storing the wallpaper corresponding to the collection instruction into the local favorite.

### Embodiment 8 of the Device

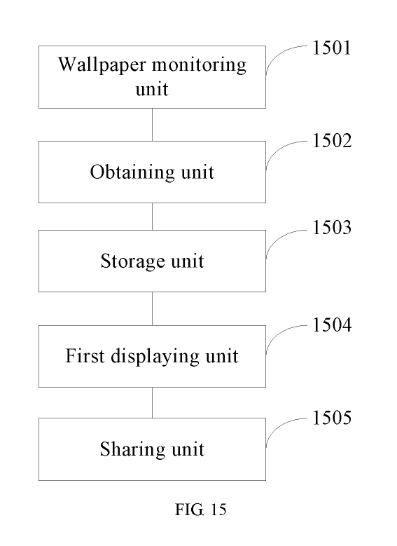

As shown in FIG. 15, the schematic structural view of the wallpaper processing device disclosed by the embodiment 8 of the present disclosure is illustrated, specifically including a wallpaper monitoring unit 1501, an obtaining unit 1502, a storage unit 1503, a first displaying unit 1504 and a sharing unit 1505;

wherein the wallpaper monitoring unit 1501 can be used for monitoring the state of the wallpaper;

the obtaining unit 1502 can be used for obtaining the changed wallpaper when the wallpaper is monitored to change; and

the storage unit 1503 can be used for storing the changed wallpaper into the wallpaper record;

the first displaying unit 1504 can be used for receiving a checking instruction of the user for checking the wallpaper record and displaying the thumbnail of the wallpaper in the wallpaper record; and the sharing unit 1505 can be used for receiving a sharing instruction of the user for sharing the wallpaper in the wallpaper record and sharing the wallpaper corresponding to the sharing instruction to a corresponding target application.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

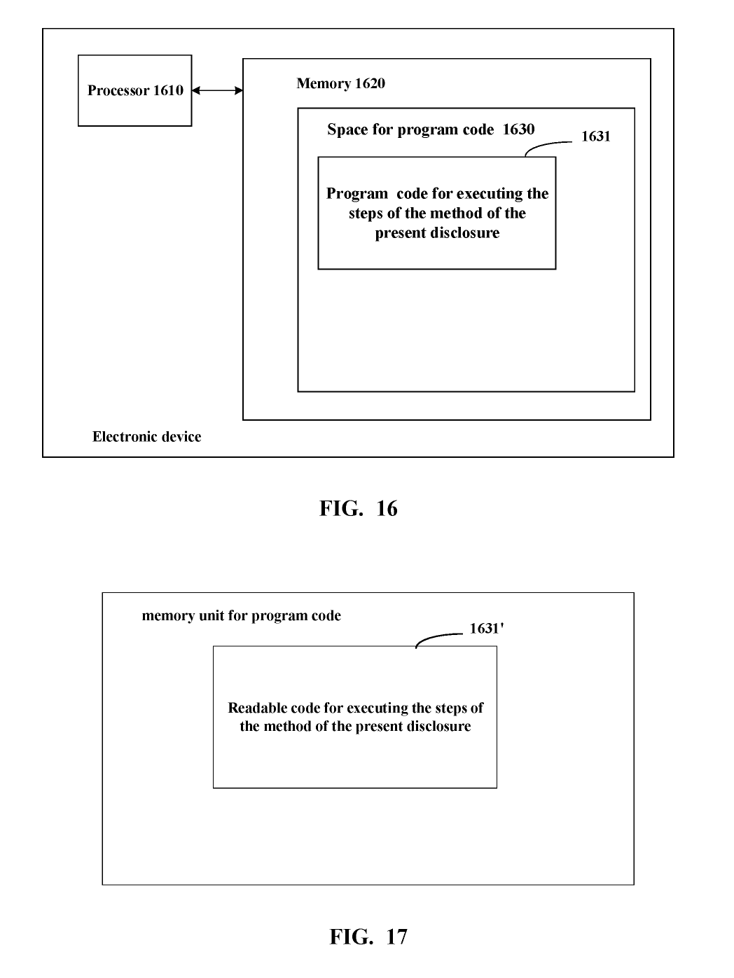

For example, FIG. 16 illustrates a block diagram of an electronic device for executing the method according the disclosure. Traditionally, the electronic device includes a processor 1610 and a computer program product or a computer readable medium in form of a memory 1620. The memory 1620 could be electronic memories such as flash memory, EEPROM (Electrically Erasable Programmable Read-Only Memory), EPROM, hard disk or ROM. The memory 1620 has a memory space 1630 for executing program codes 1631 of any steps in the above methods. For example, the memory space 1630 for program codes may include respective program codes 1631 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 17. The memory cells may be provided with memory sections, memory spaces, etc., similar to the memory 1620 of the server as shown in FIG. 16. The program codes may be compressed for example in an appropriate form. Usually, the memory cell includes computer readable codes 1631′ which can be read for example by processors 1610. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the embodiments are only used for describing the technical scheme of the present disclosure but not for limiting the technical scheme; although the present disclosure is described in detail referring to the embodiments, it will be appreciated that those skilled in the prior art can still perform modification on the technical scheme recorded in the embodiments, or perform equivalent replacement on partial technical characteristics; but the modification or the replacement does not enable the essence of the technical scheme to be broken away from the spirit and the scope of the technical scheme in each embodiment of the present disclosure.

What is claimed is:

1. A wallpaper processing method, comprising:
monitoring a state of a wallpaper;
obtaining the changed wallpaper when the wallpaper is monitored to change; and
storing the changed wallpaper into a wallpaper record.

2. The method according to claim 1, wherein monitoring the state of the wallpaper comprises:
monitoring a wallpaper setting request sent from a user through a wallpaper manager, wherein the wallpaper setting request comprises picture information;
determining that the state of the wallpaper changes, after the wallpaper manager sets the picture corresponding to the picture information as the wallpaper.

3. The method according to claim 2, wherein obtaining the changed wallpaper when the wallpaper is monitored to change comprises:
obtaining the changed wallpaper according to a picture path or picture address information in the picture information.

4. The method according to claim 1, wherein the method further comprises:
displaying a thumbnail of the wallpaper in the wallpaper record, after receiving a checking instruction of the user for checking the wallpaper record.

5. The method according to claim 4, wherein the method further comprises:
displaying the wallpaper corresponding to the selected thumbnail according to a preset size, after receiving a selection instruction of the user for selecting the thumbnail.

6. The method according to claim 4, wherein the method further comprises:
executing a deleting operation on the wallpaper corresponding to a deleting instruction, after receiving the deleting instruction of the user for deleting the wallpaper in the wallpaper record.

7. The method according to claim 4, wherein the method further comprises:
storing the wallpaper corresponding to a collection instruction into a local favorite, after receiving the collection instruction of the user for collecting the wallpaper in the wallpaper record.

8. The method according to claim 4, wherein the method further comprises:
sharing the wallpaper corresponding to a sharing instruction to a corresponding target application, after receiving the sharing instruction of the user for sharing the wallpaper in the wallpaper record.

9. An electronic device for wallpaper processing, comprising:
at least one processor; and
a memory communicably connected with the at least one processor for storing instructions executable by the at least one processor, wherein execution of the instructions by the at least one processor causes the at least one processor to:
monitor a state of a wallpaper;
obtain the changed wallpaper when the wallpaper is monitored to change; and
store the changed wallpaper into a wallpaper record.

10. The electronic device according to claim 9, wherein monitor the state of the wallpaper comprises:
monitoring a wallpaper setting request sent from a user through a wallpaper manager, wherein the wallpaper setting request comprises picture information;
determining that the state of the wallpaper changes after the wallpaper manager sets the picture corresponding to the picture information as the wallpaper.

11. The electronic device according to claim 10, wherein obtain the changed wallpaper when the wallpaper is monitored to change comprises:
obtaining the changed wallpaper according to a picture path or a picture address information in the picture information.

12. The electronic device according to claim 9, wherein execution of the instructions by the at least one processor causes the at least one processor to further:
display a thumbnail of the wallpaper in the wallpaper record, after receiving a checking instruction of the user for checking the wallpaper record.

13. The electronic device according to claim 12, wherein execution of the instructions by the at least one processor causes the at least one processor to further:
display the wallpaper corresponding to the selected thumbnail according to a preset size, after receiving a selection instruction of the user for selecting the thumbnail.

14. The electronic device according to claim 11, wherein execution of the instructions by the at least one processor causes the at least one processor to further:
execute a deleting operation on the wallpaper corresponding to a deleting instruction, after receiving the deleting instruction of the user for deleting the wallpaper in the wallpaper record.

15. The electronic device according to claim 11, wherein execution of the instructions by the at least one processor causes the at least one processor to further:
store the wallpaper corresponding to a collection instruction into a local favorite, after receiving the collection instruction of the user for collecting the wallpaper in the wallpaper record.

16. The electronic device according to claim 11, wherein execution of the instructions by the at least one processor causes the at least one processor to further:
share the wallpaper corresponding to a sharing instruction to a corresponding target application, after receiving the sharing instruction of the user for sharing the wallpaper in the wallpaper record.

17. A non-transitory computer readable medium storage medium storing executable instructions that, when executed by an electronic device, cause the electronic device to:
monitor a state of a wallpaper;
obtain the changed wallpaper when the wallpaper is monitored to change; and
store the changed wallpaper into a wallpaper record.

18. The non-transitory computer readable medium according to claim 17, wherein monitor the state of the wallpaper comprises:
monitoring a wallpaper setting request sent from a user through a wallpaper manager, wherein the wallpaper setting request comprises picture information;
determining that the state of the wallpaper changes, after the wallpaper manager sets the picture corresponding to the picture information as the wallpaper.

19. The non-transitory computer readable medium according to claim 18, wherein obtain the changed wallpaper when the wallpaper is monitored to change comprises:
obtaining the changed wallpaper according to a picture path or picture address information in the picture information.

20. The non-transitory computer readable medium according to claim 1, wherein the electronic device is further caused to:
display a thumbnail of the wallpaper in the wallpaper record, after receiving a checking instruction of the user for checking the wallpaper record.
